(19) United States
(12) Patent Application Publication
(10) Pub. No.: US 2010/0103458 A1
(43) Pub. Date: Apr. 29, 2010

(54) Printer And Printer Control Method

(75) Inventor: Keiko Negishi, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: SEIKO EPSON CORPORATION, Tokyo (JP)

(21) Appl. No.: 12/605,004

(22) Filed: Oct. 23, 2009

(30) Foreign Application Priority Data
Oct. 28, 2008 (JP) 2008-277097

(51) Int. Cl. G06K 1/00

(52) U.S. Cl. 358/1.15

(57) ABSTRACT

A printer that can acquire information related to print job execution can shorten the waiting time between print jobs even when print jobs are received continuously. In a printer that prints according to print jobs, a command interpreting and data conversion unit 10 interprets commands and converts print data to generate mechanical operation commands based on the commands and print data contained in a print job. A mechanical control unit 30 controls operation of the printer mechanism by the mechanical operation commands. A job execution manager 20 having a synchronization manager 21, job execution result manager 22, and mechanical operation command buffer 23 manages print job execution. The synchronization manager 21 synchronizes with the mechanical control unit 30 after acquiring from the mechanical control unit 30 a report that all mechanical operations for the print job have been completed. The mechanical operation command buffer 23 stores mechanical operation commands related to the next print job before all mechanical operations for the previous print job are completed. The job execution result manager 22 acquires and manages information related to the print job execution result from a printing result acquisition unit 31 each time all mechanical operations are completed for a print job. The waiting time between print jobs can therefore be shortened when print jobs are received continuously.

### CROSS-REFERENCE TO RELATED APPLICATIONS

Japanese Patent application No. 2008-277097, filed Oct. 28, 2008, is hereby incorporated by reference in its entirety.

### BACKGROUND

1. Field of Invention

The present invention relates to a printer and to a control method for a printer.

2. Description of Related Art

Japanese Unexamined Patent Appl. Pub. JP-A-2007-223300 teaches an inkjet printer that can be used in a system that counts the number of ink shots discharged when executing a print job, and bills according to the use of ink or other consumable based on the ink shot count or other metric. After successfully completing a print job and determining the ink shot count, this type of inkjet printer must send the result to a connected computer. As a result, even if the next job (print job) has been received, the next job is not processed and waits in a queue until printing the currently executing job is completed. More specifically, the inkjet printer starts converting the next print job after the printing operation for the previous job is completely finished.

The main operations involved with processing a print job in an inkjet printer according to the related art are described next. FIG. 3 is a block diagram describing the configuration of the main control units related to processing print jobs in an inkjet printer according to the related art.

Referring to FIG. 3, print jobs sent from a computer are received by a reception unit, for example. Commands and print data contained in the print job are sent to a command generator (such as command interpreting and data conversion unit 101) whereby they are interpreted and converted, and the resulting mechanical operation commands and print data are sent to a control unit (such as the mechanical control unit 102).

FIG. 4 is a flow chart showing the print job processing procedure of the inkjet printer according to the related art.

Referring to FIG. 4, when the command interpreting and data conversion unit 101 receives the commands and print data contained in a print job (step S201), the command interpreting and data conversion unit 101 starts command interpretation and data conversion. For example, command 1 and command 2 for the first pass of the print head are interpreted and converted (step S202), and the resulting operation commands (mechanical operation commands for mechanical operation 1 and mechanical operation 2) and converted print data are sent to the mechanical control unit 102 (step S203). For example, mechanical operation 1 relates to moving the carriage, and mechanical operation 2 relates to operating the print head.

The mechanical control unit 102 acquires the mechanical operation commands (mechanical operation 1 and mechanical operation 2) and the converted print data (step S204), and executes the mechanical operations (mechanical operation 1 and mechanical operation 2) for the first pass (step S205).

It should be noted that inkjet printers and other serial printers carry the print head on a carriage, and print by driving the print head while moving the carriage widthwise to the printer. One pass denotes the movement of the carriage once to either the right or left.

The command interpreting and data conversion unit 101 then interprets and converts command 3 and command 4 contained in the print job for the next pass (step S206), and sends the resulting mechanical operation commands (mechanical operation 3 and mechanical operation 4) and converted print data to the mechanical control unit 102 (step S207).

The mechanical control unit 102 receives the mechanical operation commands (mechanical operation 3 and mechanical operation 4) and converted print data (step S208), and executes the mechanical operations (mechanical operation 3 and mechanical operation 4) of the next pass (step S209).

The foregoing sequence thereafter repeats until all commands and data contained in the print job have been processed (step S210). The command interpreting and data conversion unit 101 then waits for completion of all mechanical operations from the mechanical control unit 102 (synchronization process) (step S211).

When all mechanical operations have been completed, the mechanical control unit 102 acquires the printing success/failure result for the print job (whether printing succeeded or failed) and the amount of consumables (such as the ink shot count) that were used to print the print job (step S212).

The mechanical control unit 102 then sends a mechanical operation completion report, the print success/failure report, and ink shot count to the command interpreting and data conversion unit 101 (step S213).

The command interpreting and data conversion unit 101 thus receives the mechanical operation completion report, the print success/failure report, and ink shot count (step S214).

The command interpreting and data conversion unit 101 thus stores and sends the print success/failure and ink shot count values through a communication unit to the computer, and then starts accepting commands and data for the next print job (step S215). Control thus returns to step S201 and the foregoing process repeats to execute the printing operation for the next print job.

The command interpretation and data conversion process and the actual printing operation cannot be executed for the next print job while waiting for completion of the mechanical operation (synchronization process), however, because the mechanical operation completion report, print success/failure report, and ink shot count for the first print job must be sent to the computer. Even if the next print job is received during this period, command interpretation and data conversion for the next print job cannot start immediately, and a wasteful idle period results.

Furthermore, because the print success/failure result (whether printing succeeded or failed) of the print job, and the number of ink shots used to print the print job, cannot be acquired until all mechanical operations related to the print job are completed, the inkjet printer according to the related art that is used in a system that executes a billing process such as described above must wait for completion of the mechanical operations (synchronization process), and a waiting period between print jobs cannot be eliminated when print jobs are received continuously.

### SUMMARY OF INVENTION

A printer and a printer control method according to at least of one embodiment of the present invention can acquire information related to print job execution, such as the number of ink shots used to print a print job and the printing success/failure of the print job, and can shorten the waiting time between print jobs and accelerate processing when print jobs are received continuously.

A printer according to a first aspect of the invention is a printer that can connect to a computer, the printer including a command generating unit that generates an operation command for causing a mechanism to operate based on a job received from the computer; an operation command buffer that stores the operation command; and a control unit that acquires the operation command from the operation command buffer, and executes the operation command in order to control the mechanism.

Preferably, the command generating unit generates an operation command for the mechanism based on a next print job when the next print job is received before executing the operation command based on the current job is completed; and the operation command buffer stores the operation command for the next job.

Further preferably, the printer also has a synchronization management unit that synchronizes with the control unit. The synchronization management unit synchronizes with the control unit when executing the operation command related to a job is completed, and the control unit acquires an operation command related to the next job from the operation command buffer after synchronization, and executes the operation command in order to control the mechanism.

In another aspect of the invention the printer also has a synchronization management unit that synchronizes with the control unit, the synchronization management unit prohibits the control unit from acquiring the operation command related to the next job stored in the operation command buffer until executing the operation command based on the current job is completed, and synchronizes with the control unit by allowing the control unit to acquire an operation command related to the next job stored in the operation command buffer when executing the operation command based on the current job is completed.

In another aspect of the invention the printer also a synchronization management unit that synchronizes with the control unit. The control unit notifies the synchronization management unit when executing the mechanism operation command is completed, and the synchronization management unit synchronizes with the control unit when said notification is received from the control unit.

In a printer that can acquire information about the print execution result, such as a mechanical operation completion report for print jobs, the print success/failure result, or the ink shot count, the foregoing aspects of the invention can shorten the waiting time between print jobs because the printer can store operation commands and converted print data for the next job in the operation command buffer while the printer is idle between print jobs when print jobs are continuously received.

In addition, synchronization of the control unit and the synchronization management unit (such as a job execution management unit) can be managed by delaying sending the operation commands stored in the operation command buffer to the control unit until notification of completion of the mechanism operations for the current job is received.

The printer according to another aspect of the invention also has an execution result acquisition unit that acquires information related to the operation command execution result by the control unit, and a job execution result management unit that acquires and sends said information from the execution result acquisition unit to the computer.

Further preferably, the information includes at least information related to the use of consumables in conjunction with job execution.

Further preferably, the information includes at least information denoting whether or not printing based on the job was successful.

These aspects of the invention enable acquiring the print success/failure result of print job execution, and information (such as the ink shot count) about the amount of consumables used to execute the print job, and sending this information to the computer.

Yet further preferably, the printer is a printer having a print head mounted on a carriage, and the operation command buffer stores at least the operation command executed when the carriage travels one pass.

This aspect of the invention can interpret the commands and convert the print data for at least one pass before all mechanical operations of a print job are completed because operation commands (interpreted commands and converted data, for example) for at least one pass of a print job can be stored.

Another aspect of the invention is a control method for a printer that can connect to a computer, including steps of: receiving a job from the computer; generating an operation command by a command generating unit for causing a mechanism of the printer to operate based on the job received from the computer; storing the operation command in an operation command buffer; and acquiring the operation command from the operation command buffer, and executing the operation command by a control unit in order to control the mechanism.

Preferably, the command generating unit generates an operation command for the mechanism based on a next print job when the next print job is received before executing the operation command based on the current job is completed; and the operation command buffer stores the operation command for the next job.

Further preferably, a synchronization management unit synchronizes with the control unit when executing the operation command related to a job is completed; and the control unit acquires an operation command related to the next job from the operation command buffer after synchronization, and executes the operation command in order to control the mechanism.

Further preferably, a synchronization management unit prohibits the control unit from acquiring the operation command related to the next job stored in the operation command buffer until executing the operation command based on the current job is completed, and synchronizes with the control unit by allowing the control unit to acquire an operation command related to the next job stored in the operation command buffer when executing the operation command based on the current job is completed.

Further preferably, the control unit notifies the synchronization management unit when executing the mechanism operation command is completed; and the synchronization management unit synchronizes with the control unit when said notification is received from the control unit.

In a printer that can acquire information about the print execution result, such as a mechanical operation completion report for print jobs, the print success/failure result, or the ink shot count, the foregoing control method of at least of one embodiment of the invention can shorten the waiting time between print jobs because the printer can store operation commands and converted print data for the next job in the operation command buffer while the printer is idle between print jobs when print jobs are continuously received.

In addition, synchronization of the control unit and the synchronization management unit (such as a job execution management unit) can be managed by delaying sending the operation commands stored in the operation command buffer to the control unit until notification of completion of the mechanism operations for the current job is received.

Yet further preferably, an execution result acquisition unit acquires information related to the operation command execution result by the control unit, and a job execution result management unit acquires and sends said information from the execution result acquisition unit to the computer.

Yet further preferably, the printer is an inkjet printer, and the information includes at least information related to ink consumption in conjunction with executing the job.

Yet further preferably, the information includes at least information denoting whether or not printing based on the job was successful.

These aspects of the invention enable acquiring the print success/failure result of print job execution, and information (such as the ink shot count) about the amount of consumables used to execute the print job, and sending this information to the computer.

Yet further preferably, the printer is a printer having a print head mounted on a carriage, and the operation command buffer stores at least the operation command executed when the carriage travels one pass.

This aspect of the invention can interpret the commands and convert the print data for at least one pass before all mechanical operations of a print job are completed because operation commands (interpreted commands and converted data, for example) for at least one pass of a print job can be stored.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the configuration of the main control units associated with processing print jobs in an inkjet printer according to a preferred embodiment of the invention.

FIG. 2 is a flow chart describing the steps in processing print jobs in an inkjet printer according to a preferred embodiment of the invention.

FIG. 3 is a block diagram showing the configuration of the main control units associated with processing print jobs in an inkjet printer according to the related art.

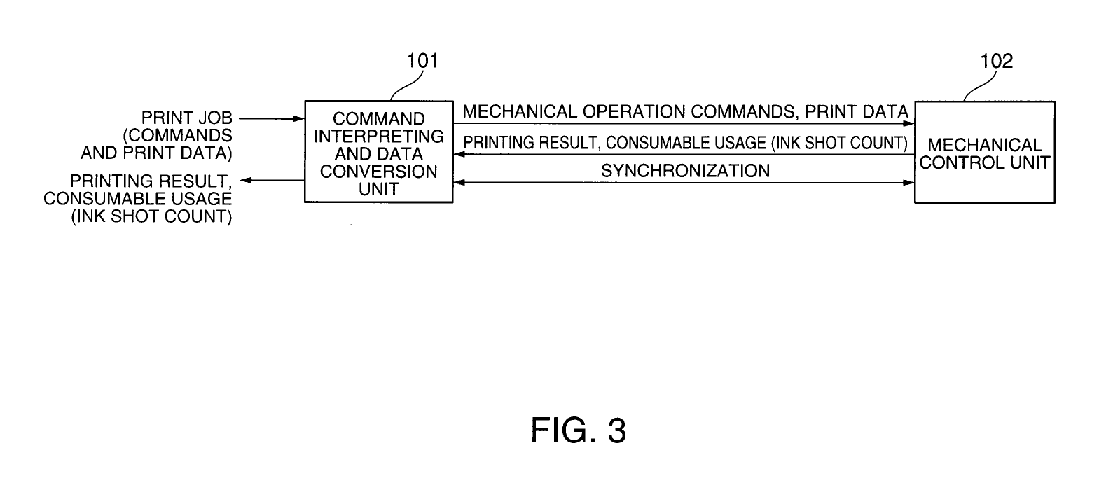

FIG. 4 is a flow chart describing the steps in processing print jobs in an inkjet printer according to the related art.

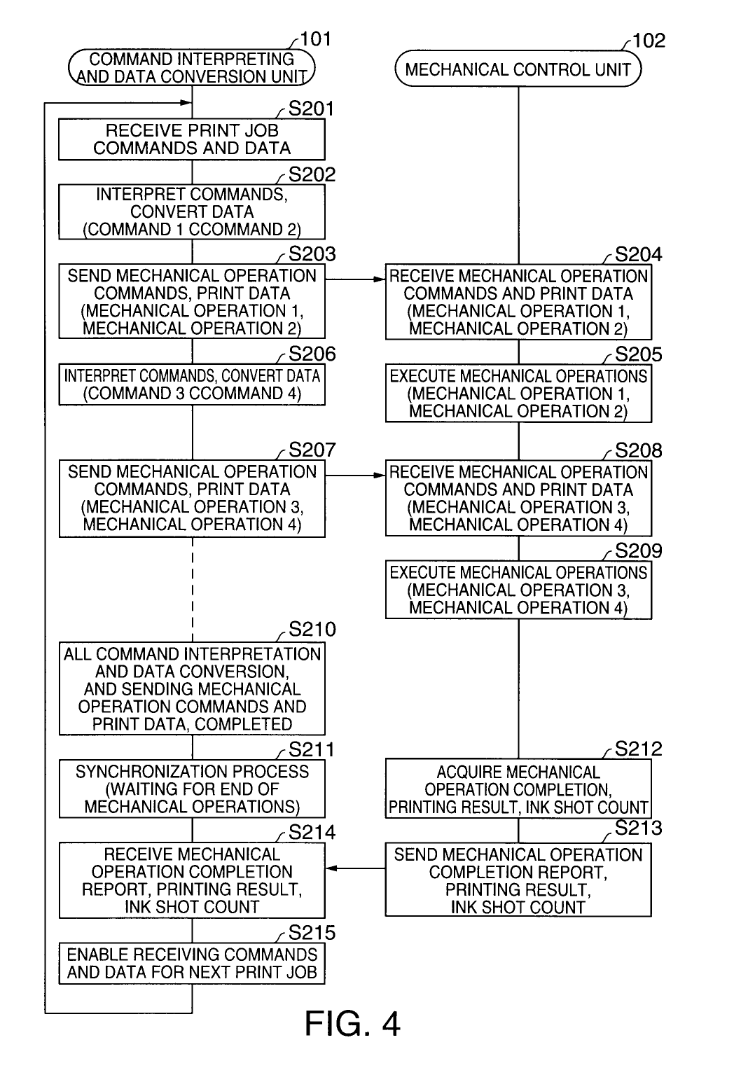

### DESCRIPTION OF THE PREFERRED EMBODIMENTS

A preferred embodiment of a printer and a printer control method according to at least of one embodiment of the present invention is described below with reference to the accompanying figures.

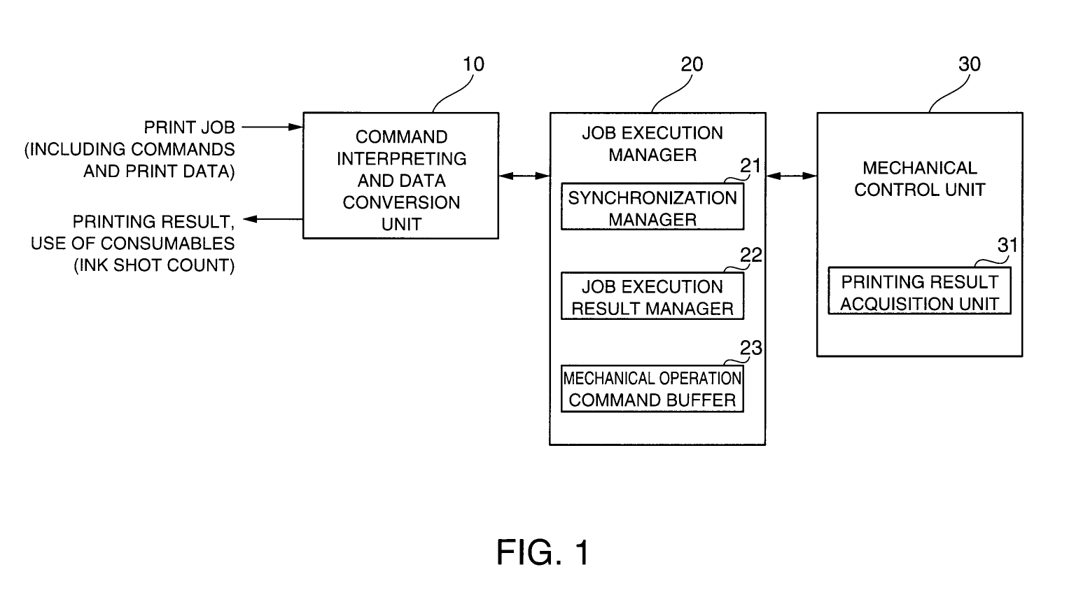

FIG. 1 is a block diagram showing the configuration of the main control units associated with processing print jobs (jobs) in a printer according to a preferred embodiment of the invention. Note that the printer is described using an inkjet printer by way of example.

The mechanical components of an inkjet printer include a print head that prints by discharging ink, a carriage on which the print head is mounted, a carriage transportation mechanism that moves the carriage bidirectionally right and left, an ink supply mechanism that supplies ink stored in an ink cartridge to the print head, and a paper transportation mechanism that conveys the paper used for printing.

When a print job sent from a computer is received by a reception unit, for example, commands and print data contained in the print job are sent to a command interpreting and data conversion unit 10 (command generating unit) whereby they are interpreted and converted, generating mechanical operation commands (operation commands) and converted print data.

The mechanical operation commands are commands in a format enabling the mechanical control unit 30 (control unit) to operate the foregoing mechanisms. These commands include, for example, operation commands whereby the carriage transportation mechanism causes the carriage to move one pass right or left, operation commands for discharging ink from specific nozzles of the print head, command causing the paper transportation mechanism to advance the paper one line, and other commands causing mechanical parts to execute specific operations based on the print job. The resulting operation commands are sent through the job execution manager 20 to the mechanical control unit 30 (control unit).

The job execution manager 20 includes a synchronization manager 21 (synchronization management unit), mechanical operation command buffer 23 (operation command buffer), and job execution result manager 22 (job execution result manager).

The synchronization manager 21 waits without sending the mechanical operation commands (operation commands) and the converted print data buffered in the mechanical operation command buffer 23 to the mechanical control unit 30, or prohibits the mechanical control unit 30 from getting mechanical operation commands and the converted print data from the mechanical operation command buffer 23, until a report that all mechanical operation commands in the print job have been completed (“mechanical operation completion report”) is acquired from the mechanical control unit 30. After receiving a mechanical operation completion report from the mechanical control unit 30, the synchronization manager 21 sends the mechanical operation commands and converted print data buffered in the mechanical operation command buffer 23 to the mechanical control unit 30, or permits the mechanical control unit 30 to acquire the mechanical operation commands and converted print data from the mechanical operation command buffer 23. More specifically, the synchronization manager 21 manages synchronization with the mechanical control unit 30.

Timed to the completion of all mechanical operations in one print job by the mechanical control unit 30, the job execution result manager 22 acquires and manages information related to print job execution each time a print job executes from the printing result acquisition unit 31 (execution result acquisition unit) of the mechanical control unit 30. This information related to print job execution includes, for example, the print success/failure result (whether printing succeeded or failed) and the use of consumables, such as the ink shot count. The acquired information related to the execution result of one print job is managed so that it can be sent to the computer, and is sent and updated each time one print job is completed.

If the next print job is received while the synchronization manager 21 and mechanical control unit 30 are synchronizing, the command interpreting and data conversion unit 10 generates the mechanical operation commands (operation commands) and converted print data, and the mechanical operation command buffer 23 buffers the converted mechanical operation commands related to the next print job. Note that the mechanical operation command buffer 23 can preferably buffer at least the interpreted commands and converted print data for one pass in the next print job.

After the synchronization manager 21 and mechanical control unit 30 synchronize, the synchronization manager 21 sends mechanical operation commands and converted print data for the next print job buffered in the mechanical operation command buffer 23 to the mechanical control unit 30, or allows the mechanical control unit 30 to get the mechanical operation commands (operation commands) and converted print data from the mechanical operation command buffer 23, and executes the print job.

The mechanical control unit 30 controls the mechanical parts of an inkjet printer according to this embodiment of the invention to execute a printing operation based on the mechanical operation commands.

A printing result acquisition unit 31 acquires information related to print job execution, such as the print success/failure result (whether printing succeeded or failed) and the number of ink shots discharged to print the job, when all mechanical operations in the one print job have been completed.

Note that the mechanical control unit 30 may be rendered as one functional unit of an inkjet-printer-specific control chip (integrated circuit chip), for example, and the printing result acquisition unit 31 may be rendered as one function thereof.

The printing result acquisition unit 31 acquires the ink shot count by a method such as counting the ink shots simultaneously to sending the ink discharge drive data to the print head. Paper consumption can be determined by counting the paper feed distance, for example.

The control method of an inkjet printer according to this embodiment of the invention is described next.

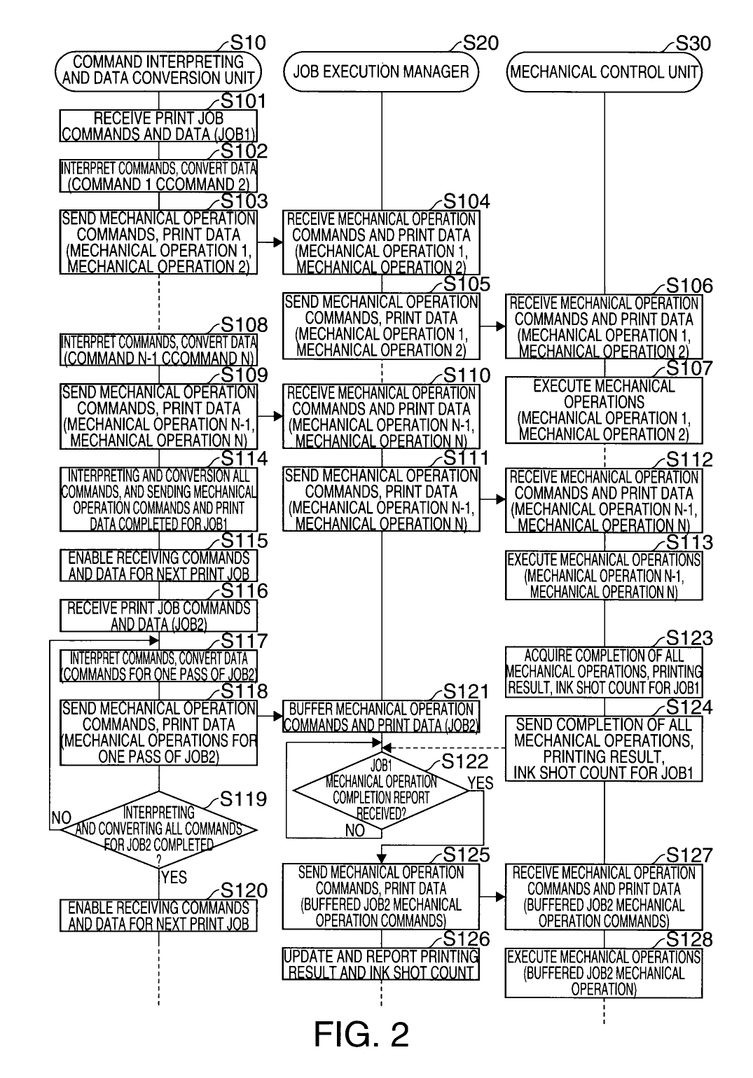

FIG. 2 is a flow chart showing the procedure related to print job processing by an inkjet printer according to this embodiment of the invention.

Referring to FIG. 2, when the command interpreting and data conversion unit 10 receives a print job (JOB1) (step S101), the command interpreting and data conversion unit 10 starts command interpretation and data conversion.

For example, the command interpreting and data conversion unit 10 interprets and converts command 1 and command 2 for one pass (step S102), and sends the resulting mechanical operation commands (operation commands for mechanical operation 1 and mechanical operation 2) and the converted print data to the job execution manager 20 (step S103). In this example, mechanical operation 1 relates to moving the carriage, and mechanical operation 2 relates to driving the print head.

The job execution manager 20 then receives the mechanical operation commands (mechanical operation 1 and mechanical operation 2) and the converted print data for JOB1 (step S104), and sends the commands and data to the mechanical control unit 30 (step S105).

The mechanical control unit 30 receives the mechanical operation commands (mechanical operation 1 and mechanical operation 2) and the converted print data for JOB1 (step S106), and executes the JOB1 mechanical operations (mechanical operation 1 and mechanical operation 2) (step S107).

By thereafter repeating this sequence of command interpretation, conversion, and mechanical operation until steps S108 to S113 are completed through command n-1 and command n for the last pass in the print job, mechanical operations 1 to n are completed by executing all commands for JOB1.

When all commands for JOB1 have been interpreted and converted, and transmitting the mechanical operation commands and print data to the job execution manager 20 is completed (step S114), the command interpreting and data conversion unit 10 enables receiving the next print job and data without waiting for all mechanical operations to be completed (step S115).

When the command interpreting and data conversion unit 10 receives the next job (JOB2) (step S116), command 1 and command 2 for the first pass in JOB2, for example, are interpreted and converted (step S117), and the resulting mechanical operation commands (mechanical operation 1 and mechanical operation 2) and the converted print data are sent to the job execution manager 20 (step S118).

Whether all command interpretation and data conversion is completed for JOB2 is then determined (step S119). Steps S117 to S119 repeat until all command interpretation and data conversion is completed for JOB2, and when all command interpretation and data conversion is completed for JOB2 (step S119 returns Yes), receiving the next print job and data is allowed (step S120). Thereafter, the same process from step S117 to S120 repeats.

The job execution manager 20 buffers the mechanical operation commands and converted print data received for JOB2 in the mechanical operation command buffer 23 (step S121).

When all mechanical operations for JOB1 are completed, the printing result acquisition unit 31 of the mechanical control unit 30 acquires information related to the result of executing the print job (the print success/failure result (whether printing succeeded or failed) and the use of consumables, such as the ink shot count, for printing) (step S123). Completion of all mechanical operations for JOB1, and the foregoing information related to the print execution result are sent to the job execution manager 20 (step S124).

The synchronization manager 21 receives the information related to the print execution result and determines if notification of completion of all mechanical operations for JOB1 was received from the mechanical control unit 30 (step S 122), and waits until notification of completion of the printing operation is received. When notification of completion of all mechanical operations for JOB1 is received (step S122 returns Yes), the mechanical operation commands and converted print data for JOB2 buffered in the mechanical operation command buffer 23 are sent to to the mechanical control unit 30 (step S125).

Note that the mechanical operation commands and converted print data for JOB2 sent sequentially from the command interpreting and data conversion unit 10 before notification of completion of all mechanical operations for JOB1 is received are sequentially buffered in the mechanical operation command buffer 23 (step S121). After notification of completion of all mechanical operations for JOB1 is received (step S122 returns Yes), the mechanical operation commands and converted print data buffered for JOB2 are sequentially sent to the mechanical control unit 30 (step S125).

The mechanical control unit 30 sequentially receives the mechanical operation commands and converted print data that was buffered in the mechanical operation command buffer 23 for JOB2 and is sent sequentially from the job execution manager 20 (step S127), and sequentially executes the mechanical operations for JOB2 (step S128).

After the job execution manager 20 receives the information related to the print execution result (the print success/failure result (whether printing succeeded or failed) and the use of consumables, such as the ink shot count, for printing) for JOB1 from the printing result acquisition unit 31 of the mechanical control unit 30, the job execution result manager 22 updates the storage of information related to the print execution result (step S126). The information related to the print execution result for JOB1 is then reported to the computer through a communication unit not shown.

Instead of delaying the command interpretation and data conversion process for the next print job until all mechanical operations related to the current print job are completed when successive print jobs are received while the foregoing process executes, this embodiment of the invention converts the next print job data into the specific mechanical operation commands for operating the mechanical assemblies and buffers the commands in the mechanical operation command buffer 23, and can thereby continuously process print jobs.

The mechanical operation commands and converted print data generated for each pass are sent to the job execution manager in the foregoing embodiment, but the number of transmitted commands and the time interval between command transmission is not so limited and may be set appropriately.

This embodiment of the invention enables an inkjet printer that can acquire information related to the result of executing a print job, such as the print success/failure result of a print job and the amount of consumables, such as the ink shot count, used for printing, to shorten the time interval between print jobs when print jobs are sent continuously to the inkjet printer.

Tests using an inkjet printer according to this embodiment of the invention confirmed that the time between print jobs can be shortened by approximately 200 ms compared with an inkjet printer according to the related art.

As a result, the waiting time of customers waiting in line can be shortened when the inkjet printer is used, for example, to print product coupons or other information together with sales receipts at the checkout counter in a supermarket.

At least of one embodiment of the invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A printer that can connect to a computer, comprising:
a command generating unit that generates an operation command for causing a mechanism to operate based on a job received from the computer;
an operation command buffer that stores the operation command; and
a control unit that acquires the operation command from the operation command buffer, and executes the operation command in order to control the mechanism.

2. The printer described in claim 1, wherein:
the command generating unit generates an operation command for the mechanism based on a next print job when the next print job is received before executing the operation command based on the current job is completed; and
the operation command buffer stores the operation command for the next job.

3. The printer described in claim 2, further comprising:
a synchronization management unit that synchronizes with the control unit,
the synchronization management unit synchronizing with the control unit when executing the operation command related to a job is completed, and
the control unit acquiring an operation command related to the next job from the operation command buffer after synchronization, and executing the operation command in order to control the mechanism.

4. The printer described in claim 2, further comprising:
a synchronization management unit that synchronizes with the control unit,
the synchronization management unit prohibiting the control unit from acquiring the operation command related to the next job stored in the operation command buffer until executing the operation command based on the current job is completed, and
synchronizing with the control unit by allowing the control unit to acquire an operation command related to the next job stored in the operation command buffer when executing the operation command based on the current job is completed.

5. The printer described in claim 1, further comprising:
a synchronization management unit that synchronizes with the control unit;
the control unit notifying the synchronization management unit when executing the mechanism operation command is completed; and
the synchronization management unit synchronizing with the control unit when said notification is received from the control unit.

6. The printer described in claim 1, further comprising:
an execution result acquisition unit that acquires information related to the operation command execution result by the control unit; and
a job execution result management unit that acquires and sends said information from the execution result acquisition unit to the computer.

7. The printer described in claim 1, wherein:
the information includes at least information related to the use of consumables in conjunction with job execution.

8. The printer described in claim 1, wherein:
the information includes at least information denoting whether or not printing based on the job was successful.

9. The printer described in claim 1, wherein:
the printer is a printer having a print head mounted on a carriage; and
the operation command buffer stores at least the operation command executed when the carriage travels one pass.

10. A control method for a printer that can connect to a computer, comprising steps of:
receiving a job from the computer;
generating an operation command by a command generating unit for causing a mechanism of the printer to operate based on the job received from the computer;
storing the operation command in an operation command buffer; and
acquiring the operation command from the operation command buffer, and executing the operation command in order to control the mechanism by a control unit.

11. The control method for a printer described in claim 10, wherein:
the command generating unit generates an operation command for the mechanism based on a next print job when the next print job is received before executing the operation command based on the current job is completed; and
the operation command buffer stores the operation command for the next job.

12. The control method for a printer described in claim 11, wherein:
a synchronization management unit synchronizes with the control unit when executing the operation command related to a job is completed; and
the control unit acquires an operation command related to the next job from the operation command buffer after synchronization, and executes the operation command in order to control the mechanism.

13. The control method for a printer described in claim 11, wherein:
a synchronization management unit prohibits the control unit from acquiring the operation command related to the next job stored in the operation command buffer until executing the operation command based on the current job is completed, and
synchronizes with the control unit by allowing the control unit to acquire an operation command related to the next job stored in the operation command buffer when executing the operation command based on the current job is completed.

14. The control method for a printer described in claim 10, wherein:
the control unit notifies the synchronization management unit when executing the mechanism operation command is completed; and
the synchronization management unit synchronizes with the control unit when said notification is received from the control unit.

15. The control method for a printer described in claim 10, wherein:
an execution result acquisition unit acquires information related to the operation command execution result by the control unit; and
a job execution result management unit acquires and sends said information from the execution result acquisition unit to the computer.

16. The control method for a printer described in claim 10, wherein:
the printer is an inkjet printer; and
the information includes at least information related to ink consumption in conjunction with executing the job.

17. The control method for a printer described in claim 10, wherein:
the information includes at least information denoting whether or not printing based on the job was successful.

18. The control method for a printer described in claim 10, wherein:
the printer is a printer having a print head mounted on a carriage; and
the operation command buffer stores at least the operation command executed when the carriage travels one pass.
